(19) United States
(12) Patent Application Publication
(10) Pub. No.: US 2013/0061870 A1
(43) Pub. Date: Mar. 14, 2013

(54) METHOD OF CLEANING FILM FORMING APPARATUS

(71) Applicants: Akio Ui, Tokyo (JP); Masato Akita, Yokohama-shi (JP)

(72) Inventors: Akio Ui, Tokyo (JP); Masato Akita, Yokohama-shi (JP)

(21) Appl. No.: 13/425,035

(22) Filed: Mar. 20, 2012

(30) Foreign Application Priority Data
Sep. 13, 2011 (JP) P2011-199229

(51) Int. Cl. B08B 7/04; B08B 5/00

(52) U.S. Cl. 134/1.1

(57) ABSTRACT

In one embodiment, a method of cleaning a film forming apparatus includes: plasmatizing cleaning gas having at least one of the group consisting of chlorine gas, hydrocarbon gas, and chlorinated hydrocarbon gas; and supplying the plasmatized cleaning gas to a heated inner part of the film forming apparatus.

### CROSS-REFERENCE TO RELATED APPLICATION

This application is based upon and claims the benefit of priority from Japanese Patent Application No. 2011-199229, filed on Sep. 13, 2011; the entire contents of which are incorporated herein by reference.

### FIELD

Embodiments described herein relate to a method of cleaning a film forming apparatus.

### BACKGROUND

In order to manufacture semiconductor devices (for example, LED (Light Emitting Diodes) or semiconductor laser devices), a film forming apparatus such as a MOCVD (Metal Organic Chemical Vapour Deposition) apparatus is used. In the MOCVD apparatus, an organic metal source gas is used to form a film on a substrate disposed in the MOCVD apparatus. At this time, the film also adheres inside the MOCVD apparatus (for example, an inner wall of a reactor, a member installed in the reactor) (generation of an adherent). There is a possibility that the adherent in the MOCVD apparatus changes a film forming condition or produces dust in the apparatus. This necessitates cleaning for removing the adherent in the MOCVD apparatus.

Various methods are usable for the cleaning. For instance, a member such as the reactor is removed from the MOCVD apparatus and the removed member can be wet-cleaned by a chemical solution. Alternatively, the removed member can be dry-cleaned with the use of a separate cleaning apparatus. Further, it is possible to dry-clean the reactor by leading cleaning gas such as chlorine gas into the MOCVD apparatus (into the reactor) and heating the reactor.

Here, when the member is removed from the MOCVD apparatus to be cleaned, it needs time to open and close the MOCVD apparatus, remove and install the member, and evacuate and purge the inside of the MOCVD apparatus. This results in a decrease in throughput of the MOCVD apparatus. Further, when a member is heated to be cleaned, it is difficult to cause a water-cooled member (for example, a gas lead-in showerhead) and the like to have a high temperature. Therefore, cleaning efficiency of the MOCVD apparatus is low, which has a possibility that residues remain (cleaning failure).

### BRIEF DESCRIPTION OF THE DRAWINGS

FIG. 1 is a schematic block diagram of a MOCVD apparatus according to an embodiment.

FIG. 2 is a flowchart showing an example of a procedure for cleaning the MOCVD apparatus 10.

FIG. 3 is a flowchart showing an example of a procedure for cleaning the MOCVD apparatus 10.

FIG. 4 is a flowchart showing an example of a procedure for cleaning the MOCVD apparatus 10.

FIG. 5 is a chart showing an effect of cleaning by remote plasma using chlorine gas.

FIG. 6 is a graph showing simulation results of the cleaning by remote plasma using chlorine gas.

FIG. 7 is a chart showing an effect of cleaning by remote plasma using hydrocarbon gas.

FIG. 8 is a graph showing vapor pressure curves of gallium compounds.

FIG. 9 is a SEM photograph of a porous film.

FIG. 10 is a SEM photograph of a porous film.

FIG. 11 is a SEM photograph showing a result obtained when a GaN film is processed under the coexistence of hydrogen radicals and chlorine radicals.

### DETAILED DESCRIPTION

In one embodiment, a method of cleaning a film forming apparatus includes: plasmatizing cleaning gas having at least one of the group consisting of chlorine gas, hydrocarbon gas, and chlorinated hydrocarbon gas; and supplying the plasmatized cleaning gas to a heated inner part of the film forming apparatus.

Hereinafter, embodiments will be described in detail with reference to the drawings.

### First Embodiment

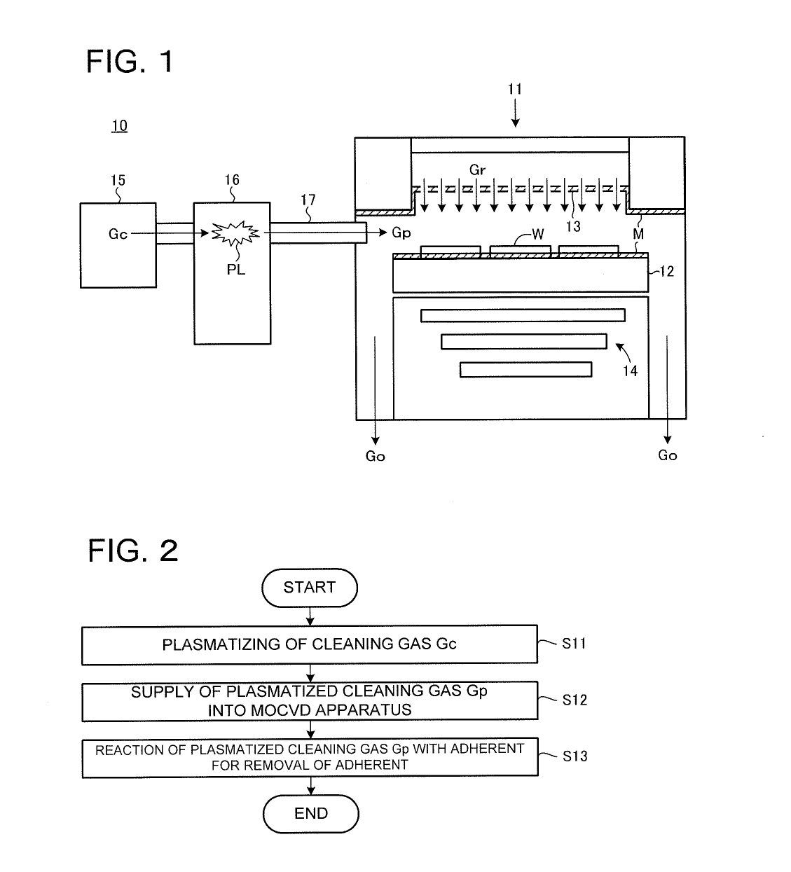

FIG. 1 is a schematic block diagram of a MOCVD apparatus 10 as the film forming apparatus according to a first embodiment. This MOCVD apparatus 10 is a vertical MOCVD apparatus and has a reactor 11, a susceptor 12, a gas supplier 13, a heater 14, a cleaning gas supplier 15, a plasma generating part 16, and a supply pipe 17.

The reactor 11 is a reaction chamber where to form a film on a substrate W through MOCVD. The inside (inner part) of the reactor 11 is kept at high vacuum by an exhaust device (for example, a turbo molecular pump) before the film formation.

The susceptor 12 is disposed in the reactor 11 and is a substrate holding part holding the substrate W placed thereon.

The gas supplier 13 is, for example, a showerhead installed in the reactor 11 and supplies MOCVD source gas Gr (for example, nitrogen gas-based trimethylgallium (Ga(CH₃)₃) and ammonia (NH₃)) into the reactor 11.

The heater 14 heats the substrate W in the reactor 11. The heater 14 heats the substrate W from a rear surface of the susceptor 12 up to, for example, about 1000° C. As a result of the supply of the MOCVD source gas Gr into the reactor 11 and the heating of the substrate W, a film of semiconductor (for example, nitride semiconductor such as GaN, InN, or AlN) is formed on the substrate W. At this time, an adherent M (substantially an integration of films) made of the constituent material of the film is formed in the MOCVD apparatus 10 (for example, on an inner wall of the reactor 11). The adherent M is made of a semiconductor material (for example, a nitride semiconductor material such as GaN, InN, or AlN).

Further, the heater 14 heats the inside of the MOCVD apparatus 10 (the inside of the reactor 11) at the time of the cleaning of the MOCVD apparatus 10 to promote the cleaning. Heating the inside of the MOCVD apparatus 10 (the inside of the reactor 11) enables the quick removal of the adherent M in the MOCVD apparatus 10 (improvement in cleaning rate Rc). Incidentally, a different heater for cleaning may be provided in addition to the heater 14.

The cleaning gas supplier 15 supplies cleaning gas Gc to the plasma generating part 16. The cleaning gas Gc includes one of the following gases (1) to (3).

(1) chlorine (Cl₂) gas
(2) hydrocarbon gas (gas of at least one kind out of methane (CH₄), ethane (C₂H₆), propane (C₃H₈), ethylene (C₂H₄), and acetylene (C₂H₂))
(3) chlorinated hydrocarbon gas (hydrocarbon-based gas containing chlorine atoms, for example, gas of at least one kind out of CH₃Cl, CH₂Cl₂, and CHCl₃)

As the gas (2), methane gas (CH₄) gas and ethane gas (C₂H₆) are desirable. Propane, ethylene, and acetylene are likely to produce later-described methylene radicals (CH₂) when plasmatized and it is difficult to increase its cleaning rate Rc. As the gas (2), methane gas (CH₄) is more desirable. Methane gas is not likely to produce methylene radicals (CH₂) when plasmatized and it is possible to easily increase its cleaning rate Rc.

As the gas (3), CH₃Cl and CHCl₃ are desirable. When CH₃Cl and CHCl₃ are used, it is possible to selectively generate CH₃ radicals and Cl radicals respectively.

As will be described later, the use of the gases (1) to (3) in a coexisting state is not necessarily preferable for the cleaning of the MOCVD apparatus 10. Therefore, with respect to gas G1 selected as the cleaning gas Gc out of the gases (1) to (3), a mixture ratio of the other gas G2 (gases (1) to (3)) (V2/V1) is preferably 1/5 or less.

V1: pressure of the selected gas

V2: pressure of the other gas

The plasma generating part 16 is an electromagnetic wave irradiating device irradiating the cleaning gas Gc with an electromagnetic wave (for example, 2.45 GHz microwave) or the like and plasmatizes the cleaning gas Gc. The plasma generating part 16 has a space where to hold the cleaning gas Gc (cleaning gas holding chamber) and irradiates the cleaning gas Gc in this space with the electromagnetic wave or the like. Specifically, the cleaning gas Gc in the cleaning gas holding chamber is plasmatized, so that the cleaning gas Gc is separated into ions and electrons (generation of plasmatized cleaning gas Gp). Further, the plasma generating part 16 may have an electrode to plasmatize the cleaning gas Gc by high-frequency power supplied to the electrode.

At this time, in addition to plasma PL itself (ions and electrons), radicals of the cleaning gas Gc (for example, chlorine radicals (Cl), hydrocarbon radicals, chlorinated hydrocarbon radicals) are generated. A radical is an atom or a group of atoms with an unpaired electron and its reactivity with other atoms and molecules is high. As will be described later, the MOCVD apparatus 10 is efficiently cleaned by these radicals.

The supply pipe 17 is a cylindrical member (for example, with a 34 mm inside diameter) and supplies the inside of the reactor 11 with the plasmatized cleaning gas Gp (plasma and radicals) generated in the plasma generating part 16. A tip of the supply pipe 17 is connected to the reactor 11. The supply pipe 17 can be made of an insulator (for example, quartz, polytetrafluoroethylene (Teflon: trademark), or ceramic).

### <Procedure for Cleaning MOCVD Apparatus 10>

After the film formation process in the MOCVD apparatus 10, for example, of several ten times, the inside of the MOCVD apparatus 10 (reactor 11) is cleaned for the purpose of ensuring stability and reproducibility of the film formation process. FIG. 2 is a flowchart showing an example of a procedure for cleaning the MOCVD apparatus 10.

### (1) Plasmatizing of Cleaning Gas Gc (Step S11)

The cleaning gas Gc is supplied from the cleaning gas supplier 15 to the plasma generating part 16. Beforehand, the processed substrate W is taken out from the MOCVD apparatus 10 (reactor 11) and the MOCVD source gas Gr is exhausted as exhaust gas Go.

Here, the cleaning gas Gc supplied to the plasma generating part 16 is led into the reactor 11 via the supply pipe 17. This is intended to fill the supply pipe 17 and the reactor 11 with the cleaning gas Gc to enable the supply of the plasmatized cleaning gas Gp from the plasma generating part 16 to the reactor 11. At this time, the inside of the reactor 11 is kept at a predetermined pressure (not less than 50 Pa nor more than 300 Pa, for example, 133.3 Pa) of a pressure gauge by a not-shown pressure adjustor. A reason why a pressure range of the cleaning gas Gc is set will be described later (refer to Example 1).

The microwave is radiated to the cleaning gas Gc in the plasma generating part 16 (cleaning gas holding chamber) to plasmatize the cleaning gas Gc (generation of the plasmatized cleaning gas Gp). That is, molecules of the cleaning gas Gc separate into ions and electrons. At this time, radicals of the cleaning gas Gc are also generated.

### (2) Supply of Plasmatized Cleaning Gas Gp to MOCVD Apparatus 10 (Step S12)

The plasmatized cleaning gas Gp (cleaning gas Gc that has been plasmatized and contains the radicals) generated in the plasma generating part 16 (cleaning gas holding chamber) is supplied from the supply pipe 17 into the MOCVD apparatus 10 (into the reactor 11).

At this time, the inside of the MOCVD apparatus 10 (inside of the reactor 11) is heated to a predetermined temperature (for example, not lower than 200° C. nor higher than 400° C., for example, 300° C.) by the heater 14 (heating of the adherent M).

(3) Reaction of Plasmatized Cleaning Gas Gp with Adherent M for Removal of Adherent M (Step S13)

The plasmatized cleaning gas Gp (the cleaning gas Gc that has been plasmatized and contains the radicals) reacts with the heated adherent M, so that the adherent M is turned into gas (for example, GaN forming the adherent M changes to GaCl₃ or Ga (CH₃)₃). The gasified adherent (for example, GaCl₃ or Ga (CH₃)₃) is exhausted as the exhaust gas G0 from an exhaust system (not shown) of the MOCVD apparatus 10. As a result, the adherent M in the MOCVD apparatus 10 (in the reactor 11) is removed.

In this embodiment, owing to the use of the plasmatized cleaning gas Gp (containing the radicals), the inside of the reactor 11 is quickly cleaned of the adherent M. As will be described later, if the cleaning gas Gc is not plasmatized, the reaction between the cleaning gas Gc and the adherent M requires a high temperature (for example, temperature of 650° C. or higher). On the other hand, plasmatizing the cleaning gas Gc enables the cleaning at about 250° C. when the cleaning gas is Cl₂ gas and about 300° C. when the cleaning gas is CH₄ gas (refer to examples 1, 2 to be described later).

If the high temperature is necessary for the cleaning, it is difficult to clean members whose temperature cannot be increased, that is, members cooled by water or the like and low heat-resistant members such as members made of aluminum. Cooled members are difficult to heat. Further, low heat-resistant members might be corroded at high temperatures. On the other hand, if the cleaning at relatively low temperature of about 400° C. or lower is possible, even cooled members and low heat-resistant members can be easily cleaned.

This is because easiness of the radical generation depends on the presence/absence of the plasmatizing. The following expression (1) represents the generation of chlorine radicals from chlorine gas by thermal energy (pyrolysis of the Cl₂ gas). Further, expressions (2), (3) represent the generation of a chlorine radical (Cl) and a methyl radical (CH₃) from chlorine gas and methane gas respectively by electron energy in the plasma PL.

Cl₂+thermal energy→2Cl expression (1)

Cl₂+electron energy(plasma)→2Cl expression (2)

CH₄+electron energy(plasma)→CH₃+H expression (3)

Pyrolysis efficiency of gas depends greatly on temperature, and high temperature of, for example, 650° C. or higher is necessary for increasing the pyrolysis efficiency of the gas (refer to the examples 1, 2 to be described later). On the other hand, high-speed electrons (high-energy electrons) are present in the plasma PL, so that the radicals (C₁, CH₃) are efficiently generated.

As a result, in the reaction between the adherent M (for example, GaN) and the radicals as represented by the following expressions (4), (5), the speed (cleaning rate Rc) differs depending on the presence/absence of the plasmatizing. The speed of the cleaning (etching) reaction of the adherent M differs depending on whether an amount of the radicals is large or small.

GaN+3Cl→GaCl₃↑+½N₂↑ expression (4)

GaN+3CH₃→Ga(CH₃)₃↑+½N₂↑ expression (5)

As described above, as a result of leading the plasmatized cleaning gas Gp generated in the plasma generating part 16 into the reactor 11 (remote plasma assist), the cleaning temperature decreases, which facilitates the cleaning of the inside of the MOCVD apparatus 10.

### Second Embodiment

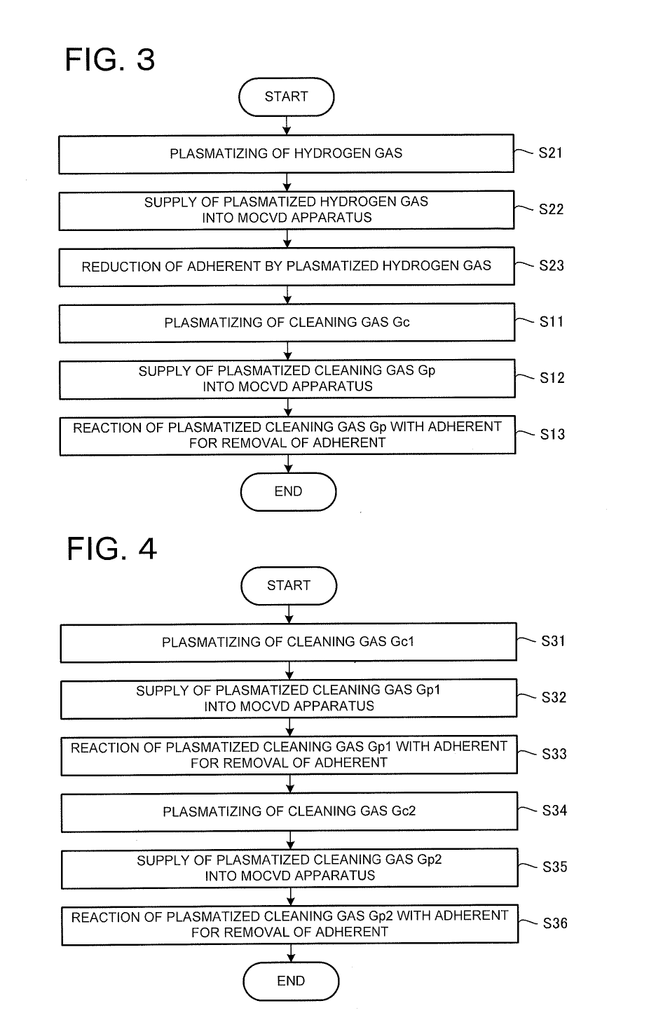

A second embodiment will be described. FIG. 3 is a flowchart showing an example of a procedure for cleaning a MOCVD apparatus 10 of the second embodiment. As the MOCVD apparatus 10, the same one as that of the first embodiment is usable.

### (1) Plasmatizing of Hydrogen Gas (Step S21)

Hydrogen gas is supplied from the cleaning gas supplier 15 to the plasma generating part 16. Beforehand, the processed substrate W is taken out from the MOCVD apparatus 10 (reactor 11) and the MOCVD source gas Gr is exhausted. Incidentally, a plasma generating part different from the plasma generating part 16 may be used to plasmatize the hydrogen gas.

Here, the hydrogen gas supplied to the plasma generating part 16 is led into the reactor 11 via the supply pipe 17. This is intended to fill the supply pipe 17 and the reactor 11 with the hydrogen gas to enable the supply of plasmatized hydrogen gas from the plasma generating part 16 to the reactor 11. At this time, the inside of the reactor 11 is kept at a predetermined pressure (not less than 50 Pa nor more than 300 Pa, for example, 133.3 Pa) by a not-shown pressure adjustor.

The microwave is radiated to the hydrogen gas in the plasma generating part 16 (cleaning gas holding chamber) to plasmatize the hydrogen gas. That is, molecules of the hydrogen gas separate into ions and electrons. At this time, radicals (H) of the hydrogen gas are also generated.

### (2) Supply of Plasmatized Hydrogen Gas to MOCVD Apparatus 10 (Step S22)

The plasmatized hydrogen gas (hydrogen gas that has been plasmatized and contains the radicals) generated in the plasma generating part 16 (in the cleaning gas holding chamber) is supplied from the supply pipe 17 into the MOCVD apparatus 10 (into the reactor 11).

At this time, the inside of the MOCVD apparatus 10 (inside of the reactor 11) is heated to a predetermined temperature (for example, not lower than 200° C. nor higher than 400° C., for example, 300° C.) by the heater 14 (heating of the adherent M). A reason why a pressure range of the hydrogen gas is set will be described later (refer to the example 1).

### (3) Reduction of Adherent M by Plasmatized Hydrogen Gas (Step S23)

The plasmatized hydrogen gas (the hydrogen gas that has been plasmatized and contains the radicals) reacts with the heated adherent M, so that the adherent M is reduced. Specifically, for example, when the adherent M has been oxidized, oxygen bonding with the adherent M reacts with hydrogen (radicals) to be removed. The oxygen reacts with the hydrogen to become water vapor and is exhausted from the exhaust system (not shown) of the MOCVD apparatus 10. The oxidized adherent M has high bond energy and does not easily react with the cleaning gas Gc or with the plasmatized cleaning gas Gp, but reducing the adherent M facilitates the reaction of the adherent M with the cleaning gas Gc.

### (4) Plasmatizing of Cleaning Gas Gc (Step S11)

### (5) Supply of Plasmatized Cleaning Gas Gp to MOCVD Apparatus 10 (Step S12)

(6) Reaction of Plasmatized Cleaning Gas Gp with Adherent M for Removal of Adherent M (Step S13)

After the adherent M is reduced, the plasmatizing of the cleaning gas Gc, the supply of the plasmatized cleaning gas Gp into the MOCVD apparatus 10 and its reaction with the adherent M for removal of the adherent M take place as in the first embodiment. In this embodiment, the processing by the cleaning gas Gc is preceded by the processing by the plasmatized hydrogen gas. Since the cleaning by the cleaning gas Gc is performed after the reduction of the adherent M by the plasmatized hydrogen gas, cleaning efficiency improves. This will be described later in detail in an example 4.

### Third Embodiment

A third embodiment will be described. FIG. 4 is a flowchart showing an example of a procedure for cleaning a MOCVD apparatus 10 according to the third embodiment. The same MOCVD apparatus 10 is usable.

### (1) Plasmatizing of Cleaning Gas Gc1 (Step S31)

### (2) Supply of Plasmatized Cleaning Gas Gp1 to MOCVD Apparatus 10 (Step S32)

(3) Reaction of Plasmatized Cleaning Gas Gp1 with Adherent M for Removal of Adherent M (Step S33)

### (4) Plasmatizing of Cleaning Gas Gc2 (Step S34)

### (5) Supply of Plasmatized Cleaning Gas Gp2 to MOCVD Apparatus 10 (Step S35)

(6) Reaction of Plasmatized Cleaning Gas Gp2 with Adherent M for Removal of Adherent M (Step S36)

In this embodiment, the cleaning by the cleaning gas G2 follows the cleaning by the cleaning gas G1. Combining the cleaning gas G1 (for example, chlorine gas) high in cleaning rate Rc and the cleaning gas G2 (for example, hydrocarbon gas) relatively low in cleaning rate Rc makes it possible to clean the inside of the MOCVD apparatus 10 at a high speed and with good finish. After the high-speed cleaning by the cleaning gas G1, it is possible to carefully clean the inside of the MOCVD apparatus 10 by the cleaning gas G2.

### Example 1

Hereinafter the example 1 will be described. The example 1 corresponds to the case, in the first embodiment, where the gas (1) is used as the cleaning gas Gc. That is, chlorine (Cl₂) gas is used as the cleaning gas Gc. Concretely, as the cleaning gas Gc, mixed gas of chlorine (Cl₂) gas and nitrogen (N₂) gas (for example, the chlorine gas and the nitrogen gas are mixed at 1:1) is used.

For example, the chlorine gas is supplied at 100 sccm and the nitrogen gas is supplied at 100 sccm, from the cleaning gas supplier 15 into the reactor 11 via the supply pipe 17. At this time, the inside of the reactor 11 is kept at not less than 50 Pa nor more than 300 Pa. Here, the pressure was set to 133.3 Pa.

900 W power is supplied to the plasma generating part 16 and 2.4 GHz microwave is radiated to the cleaning gas Gc, whereby plasma PL is generated. As a result, plazmatized cleaning gas Gp containing chlorine radicals is supplied from the supply pipe 17 into the reactor 11.

At this time, the inside of the reactor 11 is heated to 300° C. in advance. As a result, the adherent M with a 5 μm thickness adhering on the inside of the reactor 11 is removed in about twenty minutes.

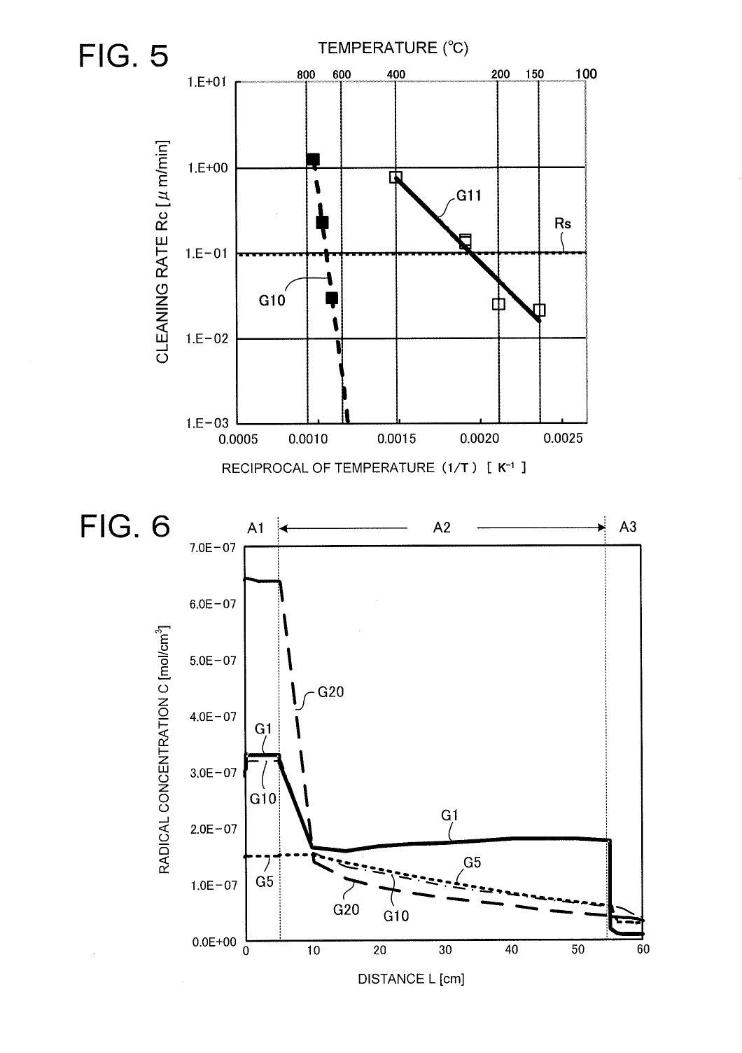

FIG. 5 is a graph showing a cleaning effect (member temperature dependency) obtained in an experiment under the above-described condition. The horizontal axis and the vertical axis of the graph represent temperature T (a reciprocal of temperature T) and cleaning rate Rc (etching rate) respectively. Graphs G10, G11 represent the cleaning rate Rc when the cleaning gas Gc (chlorine gas) is not plasmatized (pressure 100000 Pa) and when the cleaning gas Gc is plasmatized (pressure 133.3 Pa) respectively. When the cleaning gas Gc is not plasmatized, Rc is higher under a normal-pressure condition than under a pressure-reduced condition.

The cleaning rate Rc is preferably 0.1 [μm/min] (reference rate Rs) or higher. When the cleaning rate Rc is lower than the reference rate Rs, the cleaning takes a long time, which results in lack of practicability.

As shown in FIG. 5, when the chlorine gas is not plasmatized, the cleaning rate Rc equal to or higher than the reference rate Rs is obtained at temperatures of about 650° C. or higher. On the other hand, when the chlorine gas is plasmatized, the cleaning rate Rc equal to or higher than the reference rate Rs is obtained at temperatures equal to or higher than about 250° C.

As previously described, in consideration of members cooled by water cooling or the like and low heat-resistant members made of aluminum or the like, the temperature during the cleaning is preferably 400° C. or lower. That is, plasmatizing the chlorine gas enables the efficient cleaning under the condition where the temperature is within a range of 250° C. to 400° C.

Here, by using a reaction simulator CHEMKIN, the cleaning by the radicals of the chlorine gas was analyzed (simulated). FIG. 6 is a graph showing analysis results. The horizontal axis and the vertical axis of the graph represent distance L of the chlorine gas from a center of the plasma PL and Cl radical concentration C respectively. Graphs G1, G5, G10, G20 represent relations between the distance L and the radical concentration C when a gas pressure (pressure of the mixed gas of the chlorine gas and the nitrogen gas) is 133, 667, 1333, and 2666 Pa respectively.

Here, according to the distance L, a space where the radicals exist is divided into a plasma region A1, a transport region A2, and a high-temperature region A3. The plasma region A1 is a region where the plasma PL is generated (for example, a region irradiated with the microwave). As a result of the collision of the chlorine gas and electrons in the plasma region A1, chlorine radicals are generated. Therefore, the radical concentration C is high in the plasma region A1. The transport region A2 is a region where the radicals generated in the plasma region A1 are transported. In the transport region A2, the radicals disappear due to the recombination of the radicals. Therefore, in the transport region A2, the radical concentration C generally tends to decrease as the distance L increases. The high-temperature region A3 is a region whose temperature is set high by heating or the like (for example, the heated adherent M). In this high-temperature region A3, the transported radicals react actively with other atoms in the gas and on the surface to be consumed. Therefore, when the radicals enter the high-temperature region A3 from the transport region A2, the radical concentration C rapidly decreases.

As shown in FIG. 6, under a high gas pressure, for example, under a 2666 Pa pressure, the radical concentration C is high in the plasma region A1. However, the radical concentration C in the transport region A2 tends to rapidly decrease.

For the efficient cleaning by the radicals, it is important that the radical concentration C during the transport of the high-concentration radicals, that is, in the transport region A2 is high. In the course of the transport, the radicals recombine and disappear, so that there is a possibility that the number of the chlorine radicals that can reach the inner wall of the reactor 11 or the like becomes small. As shown by the graph G1 in FIG. 6, it can be said that the pressure is preferably around 133 Pa (for example, not less than 50 Pa nor more than 300 Pa). This pressure range is selected in consideration of the generation of the radicals in the plasma region A1 and the disappearance of the radicals in the transport region A2. When the pressure of the cleaning gas Gc is lower than 50 Pa, the radical concentration C in the plasma region A1 becomes small. When the pressure of the cleaning gas Gc is larger than 300 Pa, a large ratio of the radicals disappear in the transport region A2.

Here, the case of the chlorine radicals (corresponding to the gas (1)) has been described. In the case of the other radicals, for example, in the case of hydrocarbon radicals and in the case of chlorinated hydrocarbon radicals (corresponding to the gases (2), (3)), the radical concentration has the same tendency.

### Example 2

Hereinafter, the example 2 will be described. The example 2 corresponds to the case, in the first embodiment, where the gas (2) is used as the cleaning gas Gc. That is, hydrocarbon gas of at least one kind out of methane gas (CH₄), ethane gas (C₂H₆), propane gas (C₃H₈), ethylene gas (C₂H₄), and acetylene gas (C₂H₂)) is used as the cleaning gas Gc. Concretely, the methane gas (CH₄) was supplied at 100 sccm and H₂ gas was supplied at 300 sccm, from the cleaning gas supplier 15 to the plasma generating part 16.

900 W power was supplied to the plasma generating part (2.45

GHz microwave irradiating device) 16 to generate plasma PL, whereby plasmatized cleaning gas Gp containing methyl radicals (CH₃) is supplied from the supply pipe 17 into the reactor 11. At this time, the inside of the reactor 11 is heated to 300° C. in advance. As a result, the adherent M with a 5 μm thickness adhering on the inside of the reactor 11 was removed in about fifty minutes.

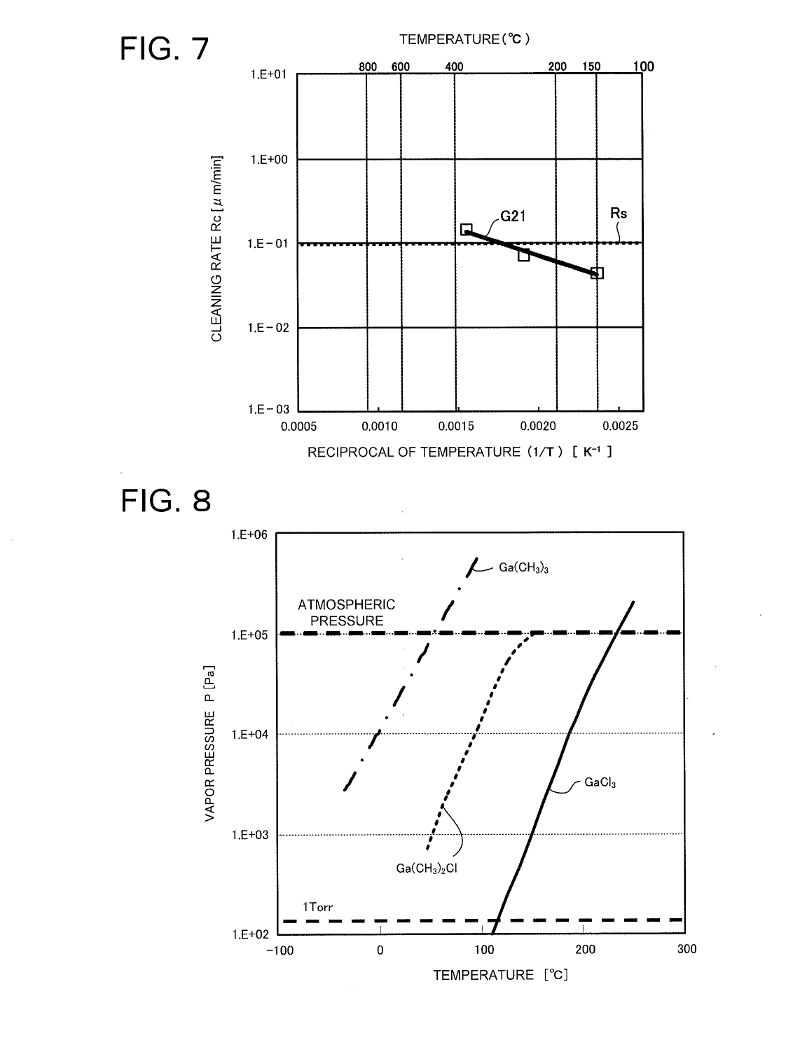

FIG. 7 is a graph showing a cleaning effect (member temperature dependency) obtained in an experiment under the above-described condition. The horizontal axis and the vertical axis of the graph represent temperature T (a reciprocal of temperature T) and cleaning rate Rc (etching rate) respectively. Graph G21 represents an etching rate when the methane gas is plasmatized (pressure 100 Pa). On the other hand, when the methane gas was not plasmatized, etching was not observed even in the high-temperature region (Rc<10⁻³ μm/min).

As shown in FIG. 7, when the methane gas is plasmatized, the cleaning rate Rc equal to or higher than the reference rate Rs is obtained at temperatures equal to or higher than about 300° C.

As previously described, the temperature during the cleaning is preferably 400° C. or lower. That is, plasmatizing hydrocarbon such as methane gas enables the efficient cleaning under the condition where the temperature is within a range of 300° C. to 400° C.

Here, mixing hydrogen gas in the cleaning gas Gc is effective to ensure the cleaning rate Rc. As a pressure ratio of the hydrocarbon gas and the hydrogen gas, 1/10 (1:10) to 1/2 (1:2) is adoptable, for instance (in the above-described example, 1/3 (1:3)). The hydrogen gas reduces the adherent M or its surrounding atmosphere to promote the decomposition of the adherent M. On the other hand, when the mixture ratio of the hydrogen gas is too high, the decomposition of the adherent M is held back due to lack of etching gas.

Further, adding the hydrogen gas to the hydrocarbon gas can prevent a hydrocarbon film (carbon film) from being formed (adhering, contaminating) in the reactor 11 and promote a cleaning reaction (refer to the expression (5)). Further, not only methyl radicals (CH₃) (refer to an expression (3)) but also methylene radicals (CH₂) are generated by the plasma (refer to an expression (6)). There is a possibility that the methylene radicals undergo polymerization reaction to form a hydrocarbon film in the supply pipe 17 and the reactor 11 (refer to an expression (7)). The addition of the hydrogen gas results in the generation of hydrogen radicals (refer to an expression (8)). The hydrogen radicals convert the methylene radicals into methyl radicals (refer to an expression (9)) and suppress the polymerization reaction (contamination of the reactor 11).

CH₄+electron energy(plasma)→CH₂+2H expression (6)

nCH₂→(CH₂)ₙ↓ expression (7)

H₂+electron energy(plasma)→2H expression (8)

CH₂+H→CH₃ expression (9)

Compared with a case where the hydrogen (H₂) gas is not added, the cleaning rate Rc increased by about ten times when the hydrogen gas was added to the hydrocarbon gas (when the gas in which the methane (CH₄) gas and the hydrogen (H₂) gas was mixed at 1:3 was used as the cleaning gas Gc).

### Example 3

Hereinafter, an example 3 will be described. The example 3 corresponds to the case, in the first embodiment, where the gas (3) is used as the cleaning gas Gc. That is, as the cleaning gas Gc, chlorinated hydrocarbon gas (hydrocarbon-based gas containing chlorine atoms, for example, gas of at least one kind out of CH₃Cl, CH₂Cl₂, and CHCl₃) is used.

The use of radicals of chlorinated hydrocarbon makes it possible to ensure a high cleaning rate Rc at a relatively low temperature. As shown in the example 1, the cleaning by the chlorine radicals needs about 250° C. temperature. This is because GaCl₃ being a product from the chlorine radicals is low in vapor pressure and its boiling point under the atmospheric pressure is 210° C. and thus is relatively high.

FIG. 8 shows vapor pressure curves of GaCl₃, Ga(CH₃)₂Cl, and Ga(CH₃)₃. As shown in FIG. 8, the larger the number of methyl radicals (CH₃) with respect to chlorine radicals (Cl) is, the more the vapor pressure tends to decrease. That is, Ga (CH₃) Cl₂, Ga (CH₃)₂Cl, and Ga (CH₃)₃ are higher in vapor pressure than GaCl₃. This indicates the capability of cleaning under lower temperatures.

However, when Cl₂ gas and CH₄ gas are directly mixed, the chlorine radicals become hydrogen chloride and further methylene radicals (CH₂ radicals) are generated (refer to expressions (10), (11)). Then, due to polymerization reaction of the methylene radicals, a carbon film (hydrocarbon film) is generated and there is a possibility that the cleaning rate Rc extremely lowers. Further, compared with chlorine radicals, hydrogen chloride radicals are lower in reactivity for cutting the bond among constituent elements of the adherent M (for example, bond of GaN).

CH₃+Cl→CH₂+HCl expression (10)

CH₃+Cl₂→CH₂+HCl+Cl expression (11)

In order to prevent the decrease of the chlorine radicals and the generation of the carbon film, chlorinated hydrocarbon (hydrocarbon-based gas containing chlorine atoms, for example, gas of at least one kind out of CH₃Cl, CH₂Cl₂, and CHCl₃) is used as the cleaning gas Gc. As a result, the generation of methylene radicals is suppressed, enabling to ensure the high cleaning rate Rc at low temperatures. Out of the chlorinated hydrocarbons, CH₃Cl and CHCl₃ are desirable. When CH₃Cl is used, it is easy to selectively generate CH₃ radicals. When CHCl₃ is used, it is easy to selectively generate Cl radicals.

### Example 4

Hereinafter, the example 4 will be described. The example 4 corresponds to the second embodiment.

In the cleaning of GaN by using chlorine radicals, it is especially necessary to prevent a component containing oxygen or oxygen atoms from mixing. If the cleaning gas Gc contains oxygen or the like, especially in a reaction process between GaN and chlorine radicals, an oxide film is likely to be generated on its surface since bond energy between Ga and oxygen is larger and more stable than bond energy between Ga and nitrogen or chlorine. As a result, there is a possibility that the cleaning rate Rc lowers.

The crystal surface of GaN is relatively stable even if exposed to oxygen. However, this oxide generation mechanism going through the process where temporary decomposition occurs via chlorine progresses far more efficiently than when GaN is simply exposed to oxygen.

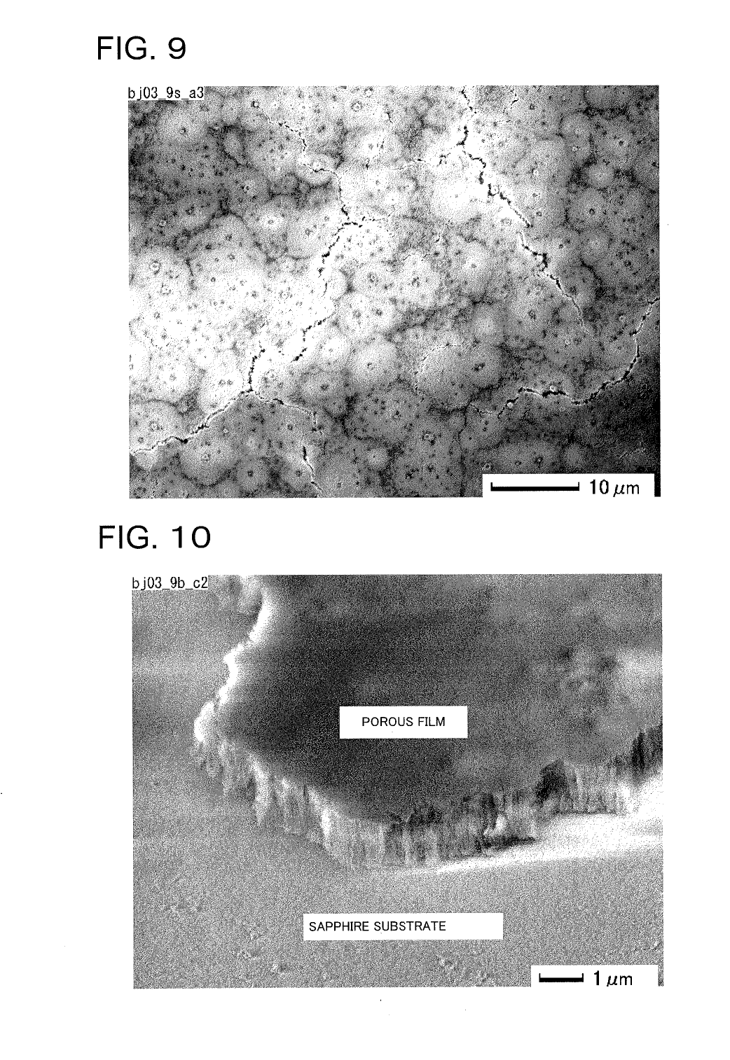

As an example, FIG. 9 and FIG. 10 show observation results of a film that remains when a GaN epitaxial film with about 2 μm formed on a sapphire substrate is exposed to 266 Pa chlorine at 700° C. FIG. 9 and FIG. 10 show an about 2000 times magnified image and an about 10000 times magnified image by a scanning electron microscope respectively. A specific porous film is growing around a threading dislocation of the sapphire substrate. The result of the component analysis showed that this porous film is substantially pure gallium oxide, with composition ratios of Ga, O, and N being 20.01, 75.46 and 4.54 at % respectively. It can be thought that gallium nitride (GaN) changed to gallium oxide.

A cause of this formation of the oxide is thought to be the mixture of oxygen into the cleaning gas Gc and the separation of an oxygen component from a constituent material (quartz, stainless steel, or the like) of the reactor 11. In the cleaning in the first embodiment (the examples 1 to 3), it is desirable that oxygen or species containing oxygen desirably does not coexist. However, in consideration of such an oxygen component separating from the constituent materials or the like of the reactor 11, it is difficult to completely eliminate the mixture of oxygen during the cleaning.

Such formation of the oxide might make the cleaning using the gases (1) to (3) difficult. In such a case, the reduction by the hydrogen radicals or the like as shown in the second embodiment is effective. That is, before the cleaning by the cleaning gas Gc, the adherent M is reduced by the hydrogen gas radicals.

As shown in the example 2, the hydrogen gas may be mixed in the cleaning gas Gc. This causes the generation of hydrogen radicals in addition to the radicals of the gases (1) to (3) when the cleaning gas Gc is plasmatized. This makes it possible to reduce the oxygen species in the gas led into the reactor 11 and in the atmosphere around the reactor 11. Further, the reduction of the adherent M by the hydrogen radicals and the removal of the adherent M by the radicals of the gases (1) to (3) can simultaneously progress.

However, when the reduction reaction and the decomposition reaction are made to progress simultaneously (when the hydrogen gas is mixed in the cleaning gas Gc), a partial pressure of hydrogen is preferably decreased to some extent. When the pressure of the hydrogen is high, the reaction of the hydrogen excessively progresses, so that the reaction by the chlorine radicals is suppressed. As a result, a reaction speed becomes as slow as that of etching by hydrogen chloride. As shown in the example 2, as a pressure ratio of hydrocarbon gas and hydrogen gas, 1/10 (1:10) to 1/2 (1:2) is adoptable, for instance (for example, 1/3 (1:3)).

When the reduction by the hydrogen radicals is performed prior to the cleaning (corresponding to the second embodiment), the pressure of the hydrogen gas need not be decreased. Further, it is also possible to alternately execute the processing by the hydrogen radicals and the processing by the chlorine radicals. The cleaning with a suppressed oxygen reaction can be achieved.

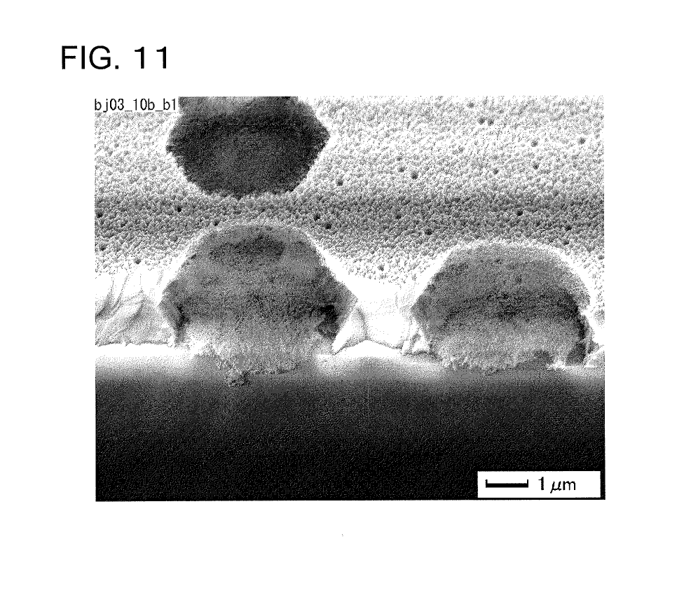

FIG. 11 shows an image by a scanning electron microscope showing a result obtained when a GaN film on a sapphire substrate is processed under the coexistence of hydrogen radicals and chlorine radicals (plasma (radicals) of cleaning gas containing hydrogen gas and chlorine gas). As is seen, it is possible to remove the adherent M (here, GaN), without generating the porous film (gallium oxide) shown in FIG. 9 and FIG. 10.

### Other Embodiments

In the foregoing, the method of cleaning the MOCVD apparatus 10 is described. This cleaning method is applicable not only to the MOCVD apparatus 10 but also to film forming apparatuses in general.

Further, the second and third embodiments may be combined, for instance. That is, it is also possible to perform the processing by the plasmatized cleaning gas Gp1 and the processing by the plasmatized cleaning gas Gp2 after the reduction process by the hydrogen radicals.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of cleaning a film forming apparatus, comprising:
plasmatizing cleaning gas having at least one of the group consisting of chlorine gas, hydrocarbon gas, and chlorinated hydrocarbon gas; and
supplying the plasmatized cleaning gas to a heated inner part of the film forming apparatus.

2. The method according to claim 1,
wherein the cleaning gas has:
the hydrocarbon gas containing at least one of methane, ethane, propane, ethylene, and acetylene; or
the chlorinated hydrocarbon gas containing at least one of CH₃Cl, CH₂Cl₂, and CHCl₃.

3. The method according to claim 1,
wherein the cleaning gas has hydrogen gas.

4. The method according to claim 1,
wherein the inner part of the film forming apparatus is filled with the cleaning gas at not less than 50 Pa nor more than 300 Pa.

5. The method according to claim 1,
wherein the inner part of the film forming apparatus is heated to not lower than 200° C. nor higher than 400°.

6. The method according to claim 1,
wherein an adherent containing at least one of GaN, InN, and AlN is disposed in the inner part of the film forming apparatus and the adherent is etched by the plasmatized cleaning gas.

7. The method according to claim 6,
wherein the film forming apparatus is a MOCVD apparatus having a reactor; and
wherein the adherent is disposed in an inner part of the reactor.

8. The method according to claim 1, further comprising
supplying plasmatized hydrogen gas to the inner part of the film forming apparatus before the supplying of the plasmatized cleaning gas.

9. The method according to claim 1,
wherein the cleaning gas has the chlorine gas, the method further comprises supplying plasmatized hydrocarbon gas to the inner part of the film forming apparatus after the supplying of the plasmatized cleaning gas.
